(19) United States
(12) Patent Application Publication
(10) Pub. No.: US 2024/0364555 A1
(43) Pub. Date: Oct. 31, 2024

(54) DISAGGREGATED SWITCHING FABRIC WITH MULTICAST NETWORK GROUP MEMBERSHIP

(71) Applicant: Cisco Technology, Inc., San Jose, CA (US)

(72) Inventors: Tapraj Singh, San Ramon, CA (US); Vijay Krishnaji Tapaskar, Palo Alto, CA (US); Praveen Bhagwatula, Cary, NC (US); Venkat Garigipati, San Jose, CA (US)

(21) Appl. No.: 18/306,397

(22) Filed: Apr. 25, 2023

(51) Int. Cl. H04L 12/18; H04L 12/44; H04L 41/12

(52) U.S. Cl. CPC H04L 12/185; H04L 12/44; H04L 41/12

(57) ABSTRACT

Disclosed are systems, apparatuses, methods, and computer-readable media for configuring network groups without software-based processing and management. A method includes: transmitting a topology request from a first leaf node to a first spine node; in response to receiving a network topology reply from a second leaf node, generating a network topology identifying a group of leaf nodes, the network topology reply including network information associated with the second leaf node, and in response to a request to send a message from a first network node connected to the first leaf node to a second network node connected to the second leaf node, transmitting the message to the second leaf node based on the network information from the network topology reply. In some aspects, the first spine node or a second spine node are configured to receive the message and transmit the message to the second leaf node.

### TECHNICAL FIELD

The disclosure relates generally to communication networks and, more specifically but not exclusively, to a disaggregated switching fabric with multicast network group membership.

### DESCRIPTION OF THE RELATED TECHNOLOGY

A data center network configuration typically consists of multiple layers, including the access layer, aggregation layer, and core layer. The access layer provides connectivity for end-user devices and servers, while the aggregation layer aggregates traffic from the access layer and provides connectivity to the core layer. The core layer is responsible for high-speed transport of data between different parts of the network.

Data center networks often use a spine-leaf topology, where multiple spine switches are connected to multiple leaf switches. The spine switches provide high-speed connectivity between the leaf switches, while the leaf switches connect to end-user devices and servers. In addition to the physical topology, data center networks may also implement virtualization technologies such as virtual local area networks (VLANs) and virtual extensible local area networks (VXLANs) to provide logical separation of network traffic. Load balancers and firewalls may also be used to provide additional security and manage traffic flows.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 is a conceptual diagram of a data center network with a spine-leaf configuration in accordance with various aspects of the disclosure;

FIG. 2 is a diagram of a disaggregated switching fabric (DSF) in accordance with various aspects of the disclosure;

FIG. 3 illustrates a packet structure used in a DSF in accordance with various aspects of the disclosure;

FIGS. 4A and 4B illustrate a leaf joining a network group in a DSF, in accordance with various aspects of the disclosure;

FIGS. 4C and 4D illustrate maintenance operations of a network group in a DSF, in accordance with various aspects of the disclosure;

FIG. 5 is a sequence diagram of a network group in a DSF in accordance with various aspects of the disclosure;

FIG. 6 illustrates an example method for configuring network groups without software-based processing and management in accordance with various aspects of the disclosure;

FIG. 7 illustrates a block diagram of a hardware component used in a network device to perform various functions in hardware in accordance with various aspects of the disclosure; and

FIG. 8 shows an example of a computing system, which can be for example any computing device that can implement components of the system.

### DETAILED DESCRIPTION

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

Disclosed are systems, apparatuses, methods, computer readable medium, and circuits for configuring a network group. According to at least one example, a method includes: transmitting a topology request from a first leaf node to a first spine node; in response to receiving a network topology reply from a second leaf node, generating a network topology identifying a group of leaf nodes, the network topology reply including network information associated with the second leaf node, and in response to a request to send a message from a first network node connected to the first leaf node to a second network node connected to the second leaf node, transmitting the message to the second leaf node based on the network information from the network topology reply, wherein the first spine node or a second spine node are configured to receive the message and transmit the message to the second leaf node. For example, the apparatus transmits a topology request from a first leaf node to a first spine node; in response to receiving a network topology reply from a second leaf node, generates a network topology identifying a group of leaf nodes, the network topology reply including network information associated with the second leaf node; and in response to a request to send a message from a first network node connected to the first leaf node to a second network node connected to the second leaf node, transmits the message to the second leaf node based on the network information from the network topology reply, wherein the first spine node or a second spine node are configured to receive the message and transmit the message to the second leaf node.

In another example, an apparatus for configuring a network group is provided that includes a storage (e.g., a memory configured to store data, such as virtual content data, one or more images, etc.) and one or more processors (e.g., implemented in circuitry) coupled to the memory and configured to execute instructions and, in conjunction with various components (e.g., a network interface, a display, an output device, etc.), cause the apparatus to: transmit a topology request from a first leaf node to a first spine node; in response to receiving a network topology reply from a second leaf node, generate a network topology identifying a group of leaf nodes, the network topology reply including network information associated with the second leaf node; and in response to a request to send a message from a first network node connected to the first leaf node to a second network node connected to the second leaf node, transmit the message to the second leaf node based on the network information from the network topology reply; wherein the first spine node or a second spine node are configured to receive the message and transmit the message to the second leaf node.

### Example Embodiments

In conventional distributed computational workloads in datacenters, congestion and head-of-line blocking are caused by large and long-lasting traffic patterns that either originate in backend networks or received and promulgated into the backend networks. Inefficient routing and challenging equal cost multipath (ECMP) routing in the fabric and per packet load-balancing are additional processing and capabilities that are additionally required to utilize full bandwidth while avoiding congestion. In some cases, distributed workloads, such as machine learning (ML) and artificial intelligence (AI) workloads frequently challenge network performance and reliability.

In some cases, the distributed workloads may increase the geographical scope of the workload due to the scale of the system. For example, the workload may initiate resources in another datacenter, which can increase delays in the processing. There are also scaling challenges with varied cable lengths due to a longer loop, and additional hops that can increase delays. These workloads can be expensive due to the computational complexity and challenges and increase provisioning hosts due to higher bandwidth consumption and power consumption.

Examples are described herein in the context of systems and methods for configuring network groups without software-based processing and management. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In some aspects, a network group is configured using multicast hardware support within a network device. For example, in a spine-leaf configuration, a node that supports multicast hardware without invoking any processing of packets in the software domain can self-manage membership and increase network functions. For example, a network can be configured for training an ML model with hundreds of millions of hyperparameters. The nodes can configure a group using multicast by various networking messages and configurations as described herein.

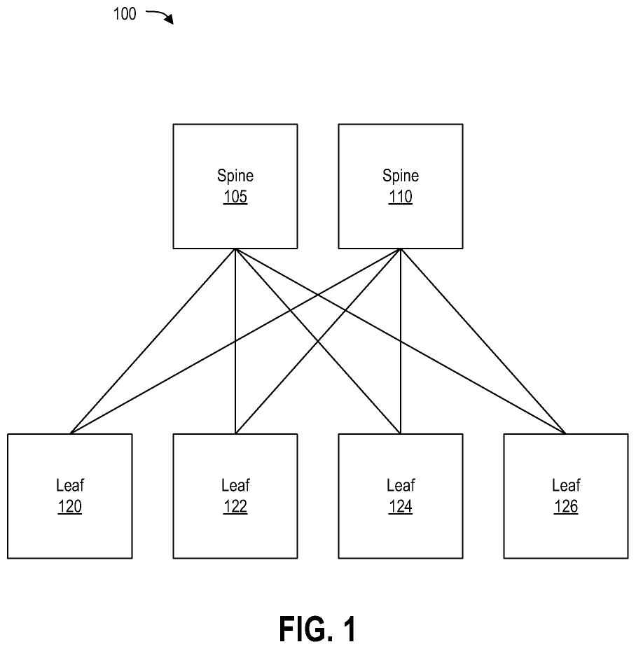

FIG. 1 is a conceptual diagram of a data center network with a spine-leaf configuration in accordance with various aspects of the disclosure. In some aspects, FIG. 1 illustrates a spine-and-leaf configuration of a Virtual Extensible Local Area Network (VXLAN), which is a scheme of layer 2 overlay on top of layer 3. In the spine-and-leaf configuration, each leaf (e.g., a lower-tier switch such as leaf 120, leaf 122, leaf 124, and leaf 126) is connected to each of the spines (e.g., a top-tier switch such as spine 105 and spine 110) in a full-mesh topology. The leaf layer consists of access switches that connect to devices such as servers. For example, as illustrated in the network 200, leaves 120-126 are interconnected with each spine 105 and 110. The spine layer is the backbone of the network and is responsible for interconnecting all leaf switches. Every leaf switch connects to every spine switch in the network. The path is randomly chosen so that the traffic load is evenly distributed among the top-tier switches. If one of the top-tier switches were to fail, it would only slightly degrade performance throughout the data center.

With a spine-and-leaf configuration, no matter which leaf switch to which a server is connected, its traffic crosses the same number of devices to get to another server, unless the other server is located on the same leaf. For example, because gateway functionality is distributed to the spine 105 and the spine 110, traffic between the nodes that are connected to a leaf is isolated within that leaf even when the two nodes of the leaves belong to different internet protocol (IP) subnets.

The network 100 configuration keeps latency at a predictable level because a payload only hops to a spine switch and another leaf switch to reach its destination. This configuration has several advantages such as scaling network capacity and increased node mobility.

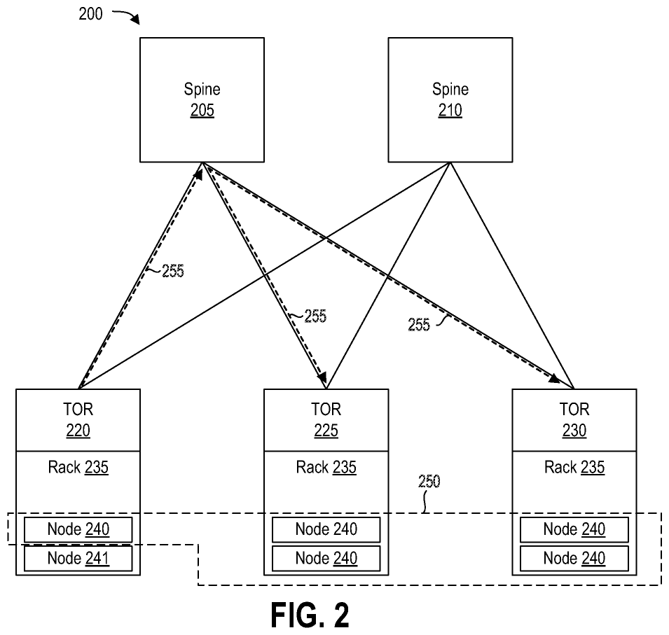

FIG. 2 is a diagram of a disaggregated switching fabric (DSF) in accordance with various aspects of the disclosure. In some aspects, the network 200 illustrated in FIG. 2 includes a first spine 205 and a second spine 210 that are each cross-coupled to a first top-of-rack (TOR) switch 220, a second TOR switch 223 and a third TOR switch 230. Each of the TOR switches includes a corresponding rack 235 and corresponds to a leaf node in FIG. 2. Each leaf node includes at least one node 240 that will be incorporated into a network group 250 for various functions. For example, the network group 250 may be configured to train an ML model, perform a simulation, or other function that requires significant parallel computations. In some cases, each TOR switch may include a node 241 that may not part of the network group 250.

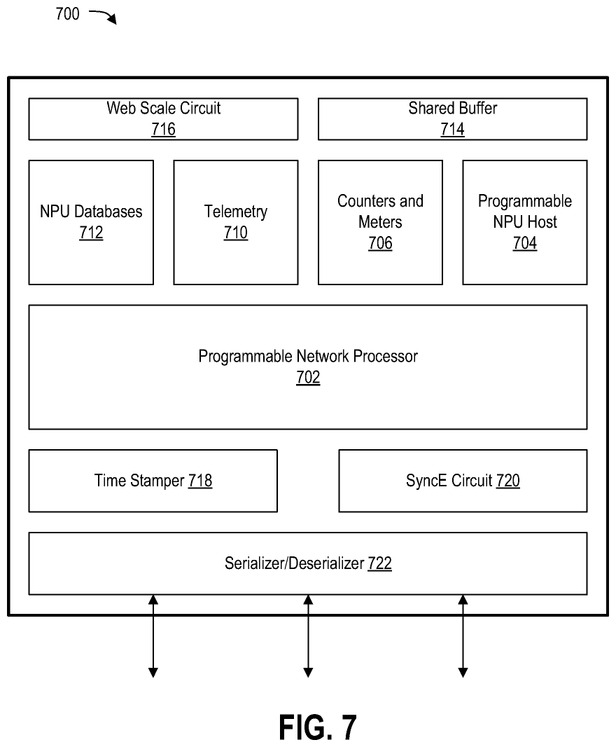

In one illustrative aspect, the network group 250 may be self-maintained by the TOR switches based on hardware capabilities of the spine and leaf nodes. In one illustrative aspect, each of the spines 205 and 210 may include multicast hardware functionality that allows the packet to be processed in hardware and without a general-purpose instruction set (e.g., X86, reduced instruction set computing (RISC), etc.). For example, a multicast packet can be processed using a programmable hardware component, which is faster and more efficient than the software-based processing. Each of the TOR switches 220, 225, and 230 may also include multicast hardware functionality and may each self-maintain the network group 250 in hardware, which can reduce connection setup, management, and connection teardown. An example of an integrated circuit capable of multicast hardware functions is illustrated in FIG. 7.

For example, the TOR switches 220, 225, and 230 may each be configured to respond to various messages associated with an L3 packet flow for directly connecting a route without any software processing. For example, a node (e.g., node 240) may transmit a multicast message to the network group 250. In this case, the node may provide a multicast packet 255 to the TOR switch 220, which performs a media access control (MAC) check and lookup in a table and provides an address and destination MAC of a destination device for the packet.

The multicast packet 255 is sent along the fabric with a packet context over the fabric using a packet spraying technique, which refers to a technique where packets are randomly distributed across all the available spines to distribute traffic and avoid overwhelming any single switch or link. For example, the TOR switch 220 sends the multicast packet 255 to the spine 205, which forwards the multicast packet 255 to the second TOR switch 225 and the third TOR switch 230.

In this network configuration, because the routing within the network group 250 generally occurs within hardware (e.g., due to the multicast hardware capabilities), the DSF configuration includes dynamic states such as a host route and border gateway protocol (BGP) learned route, which need to be distributed among all the leaf nodes participating in the DSF cluster. The dynamic states enable packet forwarding decisions on ingress node and the DSF can be configured to distribute interface configuration. The DSF configuration should distribute interface configuration, interface and system port status, encapsulation information (e.g. encapsulation information), directly connected host route information, and indirect/BGP learned host route information. Table 1 below illustrates example messages and their functions.

| Message | Message Type | Function |
|---|---|---|
| Topology Discovery | Broadcast | Topology discovery |
| Topology Discovery Reply | Unicast | Network configuration |
| DSF state update | Multicast | Network updates |
| DSF Keepalive | Multicast | Device status |

In some aspects, a topology discovery request is broadcasted when a new node is brought online and broadcasts a message to other nodes. The topology discovery reply is provided by nodes within the network and provides information associated with each leaf including interface and system port status, host routes, encapsulation indexes, and so forth. The DSF state update is multicast from a leaf when there is a dynamic change on a given node and may include interface and system port status, host routes, encapsulation indexes, and so forth. The DSF keepalive message is a message that is configured to maintain a shared state. Further aspects of the message are described in further detail below.

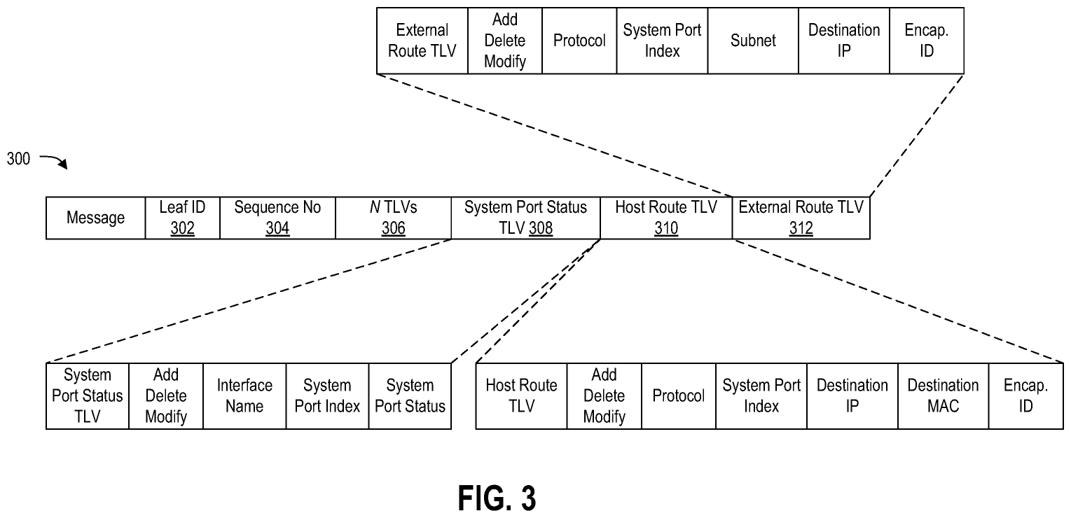

FIG. 3 illustrates a DSF message 300 and its structure in accordance with various aspects of the disclosure. In some aspects, the message 300 includes a leaf identifier (ID) 302. a sequence number 304, a number of type-length-values (TLVs) 306 that encode optional information elements within the message 300, a system port status TLV 308, a host route TLV 310, and an external route TLV 312.

In some aspects, the system port status TLV 308 can include an instruction (e.g., add, delete, modify) associated with an interface name, a system port index, and a system port status. The host route TLV 310 can also include an instruction (e.g., add, delete, modify) associated with a protocol, system port index, destination internet protocol (IP) address, destination MAC address, and encapsulation ID. The external route TLV 312 can also include an instruction (e.g., add, delete, modify) associated with a protocol, a system port index, a subnet, a destination IP, and an encapsulation ID.

In some cases, the DSF configuration information can be encoded TLVs in the DSF message 300. For example, the topology discovery reply can be encoded into the system port status TLV 308, and the DSF state update can be encoded into the system port status TLV 308, the host route TLV 310, or the external route TLV 312. In some aspects, the topology discovery is a broadcast message and does not need the particulars of the DSF message 300 to invoke a response from leaf devices, and the DSF state update also can be a simple response to indicate its current state, as further described below.

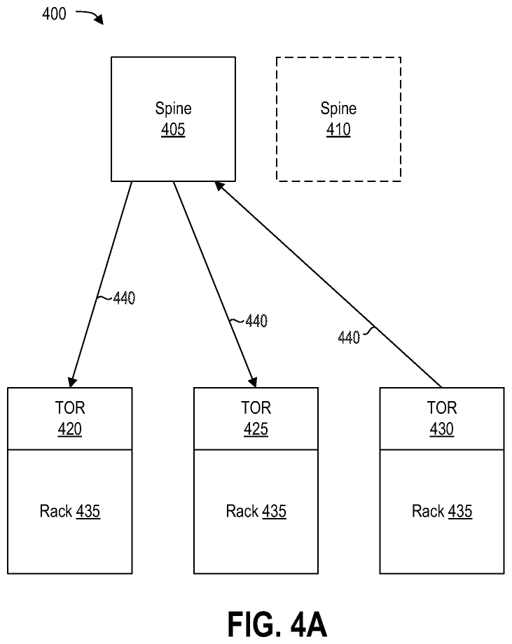

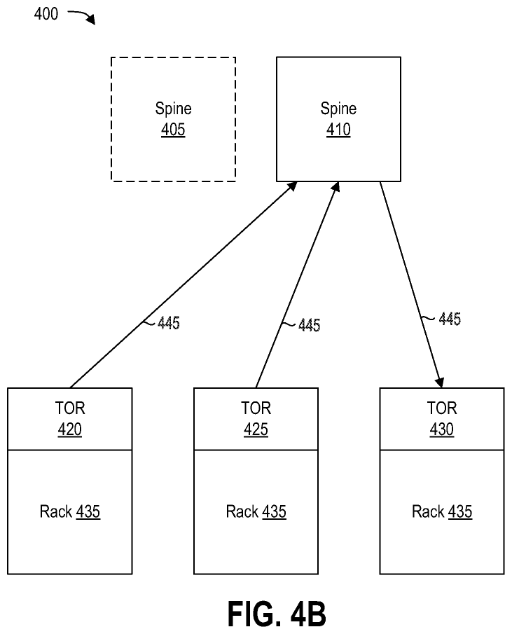

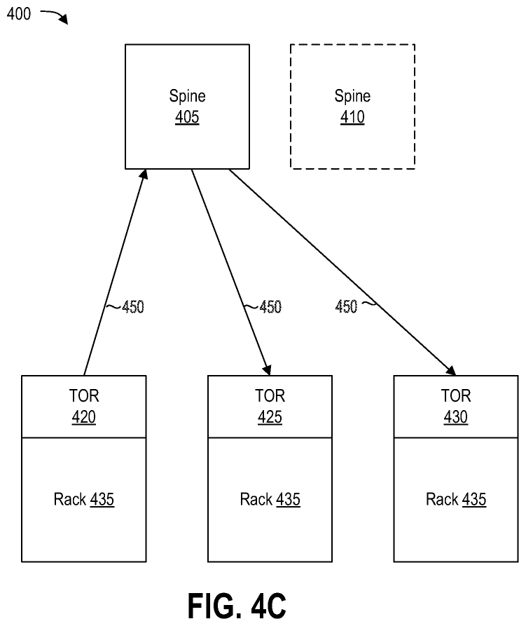

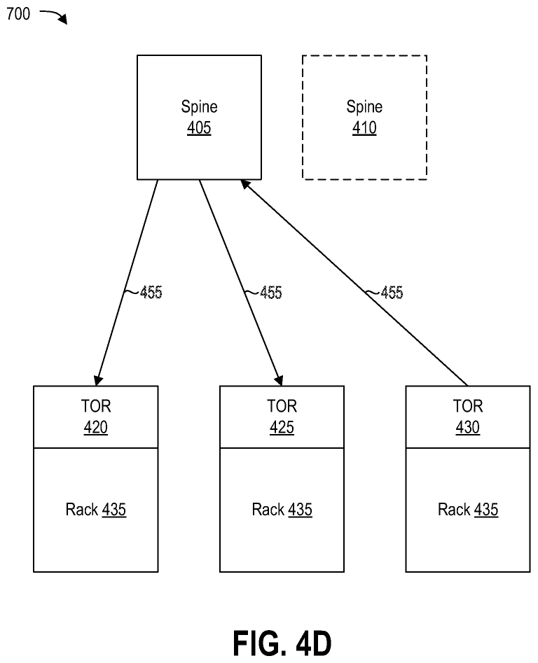

FIGS. 4A to 4D illustrates an example network 400, including a first spine 405 and a second spine 410. Each of the spines 405 and 410 is connected to each leaf illustrated at TOR switch 420. TOR switch 425, and TOR switch 430. Each of the TOR switches 420, 425, and 430 includes a rack 435 that contains network nodes. The network nodes in the rack 435 are connected to the corresponding TOR switch for receiving data.

In some aspects, FIGS. 4A and 4B illustrate a leaf joining a network group in a DSF, in accordance with various aspects of the disclosure. As described above, the network group may be configured to be network function that requires nodes to be dynamically activated and deactivated. For example, the network function may be an ML training operation in a datacenter and the proprietor may dynamically add and remove hardware to the ML training operation. As an example, the proprietor may elect to increase hardware processing capabilities at night to reduce costs (e.g., due to less heating requirements, cheaper datacenter pricing, etc.).

In the aspect illustrated in FIG. 4A, the TOR switch 430 may support multicast functionality at the hardware level and may be added to the network 400 and may be unaware of assets within the network 400. In this case, TOR switch 430 may broadcast a topology request 440. In this case, the network 400 supports transparent transmission and either the spine 405 or the spine 410 may receive the topology request. The spine 405 receives the topology request 440 and then broadcasts the topology request 440 to all nodes, including the TOR switch 420 and the TOR switch 425.

In the aspect illustrated in FIG. 4B, the TOR switch 420 and TOR switch 425 each receive the topology request. The topology request includes information that may indicate that the TOR switch 430 supports hardware-based DSF networking configuration. In this case, the TOR switch 420 and TOR switch 425 both support hardware-based DSF networking configuration and send a topology discovery reply 445 to the TOR switch 430. In this case, the topology discovery reply 445 may be transmitted transparently, and either the spine 405 or the spine 410 may receive the topology discovery reply 445. In this case, the spine 410 receives the topology discovery reply 445 and provides each topology discovery reply 445 to the TOR switch 430. Any topology discovery reply 445 can be received by either of the spines 405 and 410 are illustrated in FIG. 4B is being received by spine 410 for clarity.

The TOR switch 430 can process the topology discovery replies 445 in hardware and can build a neighbor topology table. In some aspects, each topology discovery reply can include network information associated with a sender of the topology discovery reply. The TOR switch 430 learns of the aggregate network topology based on each reply from distinct leaf nodes, or the TOR switches 220 and 225 in this case. In some aspects, the topology discovery reply includes an acknowledgment and local leaf information in various TLVs. For example, as noted above, the topology discovery reply can include various networking information such as interface status, system port status, host routes, encapsulation indexes, and so forth.

The TOR switch 430 processes the topology discovery replies 445 at the hardware level and stores the information. For example, each TOR switch 420, 425, and 430 independently store information related to other TOR switches, host routes, system ports, etc. in a hardware buffer. The TOR switch 430 does not need to invoke an interrupt of a general-purpose processor to perform software-based functions and is able to process multi-terabit networking services. Once the TOR switch 430 begins to receive the topology discovery replies 445, the TOR switch 430 can enable node devices to access network services and perform networking functions. For example, an ML training operation may be training using hundreds of millions of hyperparameters and, due to the number of computations, an operator may activate additional nodes in the TOR switch 430 to expedite the ML training operation.

FIGS. 4C and 4D illustrate maintenance operations of a DSF network group, in accordance with various aspects of the disclosure. In one aspect, each device in the network group may be configured to send a keepalive message 450 to each other device, which causes the other device to maintain the transmitting device as part of a network group.

In the illustrative aspect of FIG. 4C, the TOR switch 420 transparently multicasts a keepalive message 450, which can be received by either spine 405 or 410. In this case, the spine 405 receives the keepalive message 450, and then multicasts the keepalive message 450 to the TOR switch 425 and the TOR switch 430. In this case, because the first spine 405 includes multicast hardware, the first spine 405 does not invoke processor-based resources and can send the keepalive message 450 without requiring software functionality. In this case, the TOR switch 425 and the TOR switch 430 can receive the keepalive message 450 and process the keepalive message 450 using hardware resources.

According to aspects of the disclosure, the keepalive message 450 is configured to be transmitted on an interval to indicate that the hardware resources from the transmitting device (e.g., the TOR switch 420) are still available. An example interval is every second, and this interval can vary from hundreds of milliseconds to several seconds. In general, each of the TOR switch 420, the TOR switch 425, and the TOR switch 430 maintain networking configuration and the keepalive message 450 provides a device status of transmitting device. For example, the keepalive message 450 indicates that the TOR switch 420 is still part of the network group and resources are available to other devices (e.g., the TOR switch 425 and the TOR switch 430) as part of the network function.

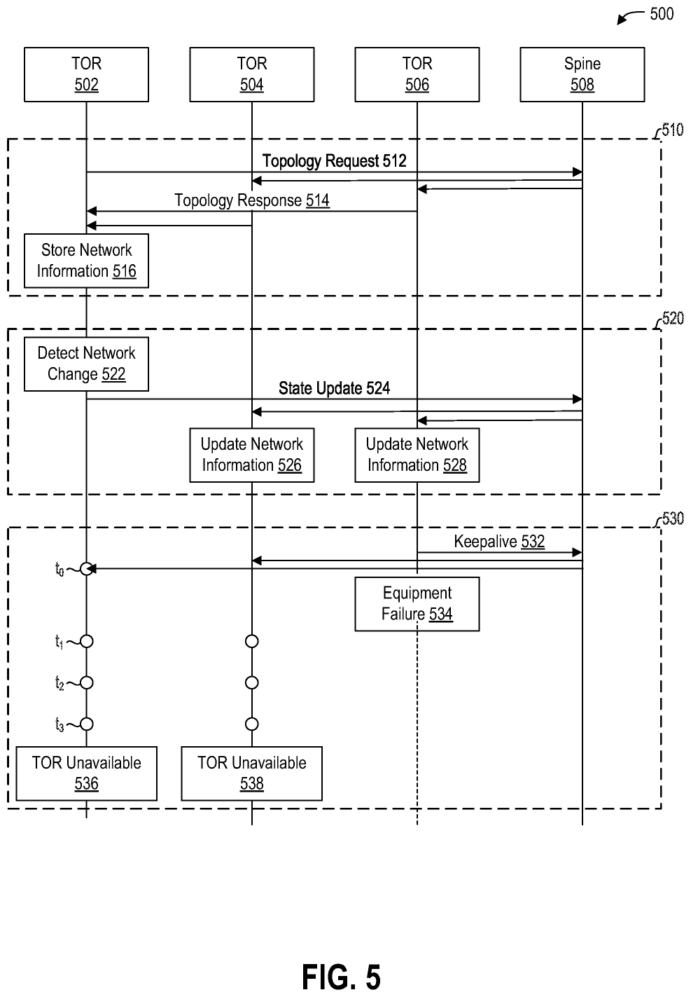

In some aspects, in the event that a minimum number of keepalive messages are not consecutively received, each device in the network group may independently determine that the non-transmitting device has become unavailable and is removed. An example minimum number of keepalive messages is 3, which is further illustrated in FIG. 5. For example, if the TOR switch 420 does not transmit three consecutive keepalive messages within 3 seconds, the TOR switch 425 and the TOR switch 430 may determine that the TOR switch 420 is unavailable and remove network information corresponding the TOR switch 420 for their hardware buffers.

The TOR switch 420, the TOR switch 425, and the TOR switch 430 each independently maintain a network state based on the keepalive message 450 based on multicast support at the hardware level of the first spine 405, the second spine 410, the TOR switch 420, the TOR switch 425, and the TOR switch 430. The DSF configuration allows hardware-supported networking without any software operation, which dynamically allocates resources to improve throughput. For example, training hundreds of millions of hyperparameters associated with a generative pre-trained transformer (GPT) can incur serious network traffic, and the network 400 can balance a high volume of network traffic while avoiding congestion, reduce delays due to cable length, and so forth.

In the illustrative aspect of FIG. 4D, the leaf devices of the network may be configured to multicast a state update message 455. In the illustrated example, the TOR switch 430 receives information indicating an update to a network configuration. The TOR switch 430 generates and multicasts the state update message 455. Either one of the spines 405 and 410 may receive the state update message 455, and then multicasts the state update message to all other members of the network group, including the TOR switch 420 and the TOR switch 425. In some aspects, the TOR switch 420 and the TOR switch 425 independently process the state update message 455 in hardware devices and update information.

In some cases, the TOR switch 420, the TOR switch 425, and the TOR switch 430 independently maintain a network configuration at the hardware level, for example in hardware buffers, to ensure that each device shares a common network state. Hardware multicasting support enables the TOR switch 420, the TOR switch 425, and the TOR switch 430 to setup, maintain, and remove devices independently and allow network functions to be scaled in a datacenter with minimal delays.

FIG. 5 is a sequence diagram 500 of a network group in a DSF in accordance with various aspects of the disclosure. In some aspects, the network includes a first TOR switch 502, a second TOR switch 504, a third TOR switch 506, and a spine 508. The network configuration will include a second spine that is omitted for clarity. As described above, the first TOR switch 502, the second TOR switch 504, and the third TOR switch 506 transmit message transparently and the spine 508 or the other spine (not shown) receive the message and perform any network functions before relaying the messages to corresponding devices.

In one illustrative aspect, the sequence diagram 500 illustrates dynamic adding of leaf devices at block 510, dynamic modification of network configuration at block 520, and dynamic maintenance of network configuration at block 530.

In one illustrative example, the first TOR switch 502 may be configured to check to identify hardware-level support of networking services, such as a DSF network. The 502 broadcasts a topology request 512, and the spine 508 provides the topology request 512 to the second TOR switch 504 and the third TOR switch 506. In response to the topology request 512, the second TOR switch 504 and the third TOR switch 506 identify pertinent networking information (e.g., interfaces, system ports, network routes) and each provides a unicast topology response 514.

At block 516, the first TOR switch 502 is configured to store the network information in hardware buffers. For example, network information can identify system port status, interfaces, protocols, and other pertinent information to allow the first TOR switch 502 to peer with the second TOR switch 504 and the third TOR switch 506 for various network functions, such as training an ML model.

At block 522, the first TOR switch 502 may detect network changes internally, such as a route change. In response to the detected network change, the first TOR switch 502 transparently multicasts a state update message 524 to the spine 508 (or other spine that is not shown), and the receiving spine provides the state update message 524 to the second TOR switch 504 and the third TOR switch 506. As noted above, because the spine 508 includes hardware multicast support, the spine 508 efficiently processes and relays the state update message 524 to associated devices.

The second TOR switch 504 and the third TOR switch 506 each receive the state update message 524 and update network information based on the changes in the state update message 524. For example, presuming the state update message 524 includes a route modification, the second TOR switch 504 updates network information stored in hardware buffers at block 526, and the third TOR switch 506 updates network information stored in hardware buffers at block 528.

For illustrative purposes, the third TOR switch 506 is illustrated as providing a keepalive message 532 at time t₀. However, each of the first TOR switch 502, the second TOR switch 504, and the third TOR switch 506 provide keepalive messages. Between time t₀ and t₁, the third TOR switch 506 experiences an equipment failure and becomes unavailable for subsequent transmission.

At time t₁, both the first TOR switch 502 and the second TOR switch 504 determine that a keepalive message is not received and increment a counter. At time t₂, the third TOR switch 506 is still unavailable and the first TOR switch 502 and the second TOR switch 504 determine that a keepalive message is not received and increment a counter. At time t₃, the third TOR switch 506 is still unavailable and the first TOR switch 502 and the second TOR switch 504 determine that a keepalive message is not received and increment a counter. When the counter reaches 3 (or zero in the case of a countdown timer), the first TOR switch 502 determines that the third TOR switch 506 is unavailable and removes associated resources in the first TOR switch 502 at block 536. The second TOR switch 504 also determines that the third TOR switch 506 is unavailable and removes associated resources in the first TOR switch 502 at block 538.

In this case, the first TOR switch 502 and the second TOR switch 504 generally have a shared state that is maintained in hardware devices. The various devices allow rapid setup and teardown of networking configuration, with minimal delays.

In some cases, the first TOR switch 502 and the second TOR switch 504 may include a countdown timer that is reset based on every keepalive message. For example, the countdown timer may have a time delay of 3 seconds, and a keepalive message resets the countdown timer.

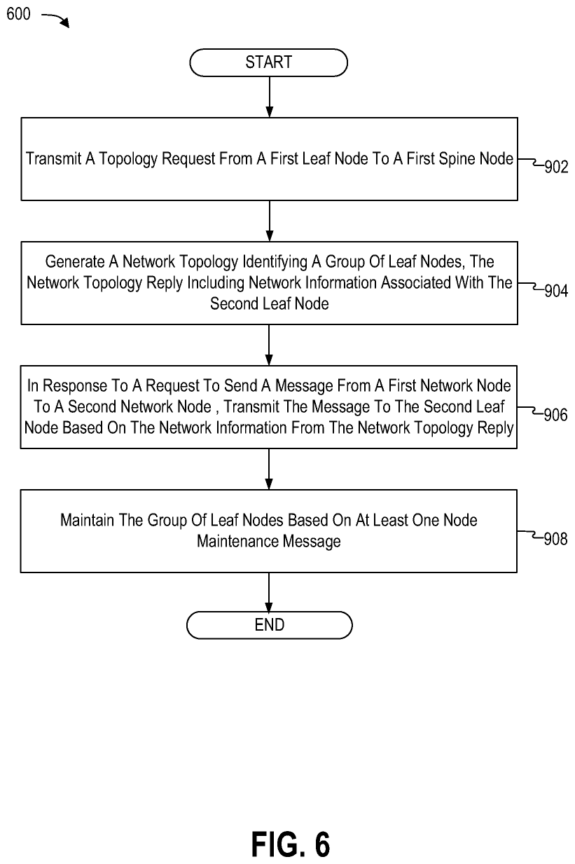

FIG. 6 illustrates an example method for configuring network groups without software-based processing and management. Although the example method 600 depicts a particular sequence of operations, the sequence can be altered without departing from the scope of the present disclosure. For example, some of the operations depicted can be performed in parallel or in a different sequence that does not materially affect the function of the method 600. In other examples, different components of an example device or system that implements the method 600 can perform functions at substantially the same time or in a specific sequence. Although a leaf node or network device (e.g., using the application specific integrated circuit (ASIC) 700, etc.) is described as performing the method, this example is for descriptive purposes. The method may be performed in a distributed manner using cloud computing. various containers, microservices, and other techniques.

At block 602, a leaf node may transmit a topology request to a first spine node. For example, the leaf node may be enabled to connect with a group of nodes associated with a spine-leaf network configuration. In this case, the topology request is broadcasted to leaf nodes connected to the first spine and the second spine.

At block 602, the leaf node may, in response to receiving a network topology reply from a second leaf node, generate a network topology identifying a group of leaf nodes. In some aspect, each leaf node may transmit the network topology reply using unicast, and each network topology reply includes network information associated with that leaf node (e.g., routes, ports, etc.). For example, the network topology reply includes network information associated with the second leaf node. The leaf node may generate a network topology based on each reply.

In some aspects, the network information includes at least one TLV including at least one of interface information, port information of the second leaf node, host routes associated with the second leaf node, and encapsulation information. The group of leaf nodes may be stored in a hardware buffer of the first leaf node because the leaf nodes are capable of processing multicast messages without a software layer (e.g., using a general-purpose processor).

At block 606, the leaf node may, in response to a request to send a message from a first network node connected to the first leaf node to a second network node connected to the second leaf node, transmit the message to the second leaf node based on the network information from the network topology reply. In some cases, the first spine node or a second spine node is configured to receive the message and transmit the message to the second leaf node.

At block 608, the leaf node may be configured to maintain the group of leaf nodes based on at least one node maintenance message. For example, block 608 can include receiving keep alive messages from each leaf node in the group of leaf nodes, wherein each keepalive message is multicast from a corresponding leaf node. The keepalive message are received on a regular interval between 50 milliseconds and 5000 milliseconds. The leaf node can determine at least three sequential keepalive messages from the second leaf node have not been received by the first leaf node; and remove the second leaf node from the set of leaf nodes and the network information associated with the second leaf node. In another example, block 608 can include multicasting a keepalive message on a regular interval.

In another example, block 608 can include identifying a network change associated with an edge device connected to the first leaf node; and multicasting a network change message including the network change. In this case, the message is addressed to the group of leaf nodes.

In some aspects, the first spine node and the second spine node are configured to multicast the network change message to the group of leaf nodes without providing the network change message to a software layer. For example, the group of leaf nodes is configured to train a machine learning model and the network operations described herein can be used for rapid setup and teardown of network functions. In some aspects, the first leaf node, the second leaf node, the first spine node, and the second spine node each include a hardware circuit that is configured to multicast messages without providing message to a software layer for inspection.

FIG. 7 illustrates a block diagram of an ASIC 700 used in a network device to perform various functions in hardware in accordance with various aspects of the disclosure. For example, the ASIC 700 can include fixed hardware components and programmable hardware components to perform various network tasks. In one illustrative aspect, the ASIC 700 includes a programmable network processor 702 (e.g., a network processing unit (NPU), etc.), a programmable NPU host 704, counters and meters 706, telemetry 710, an NPU database 712, a shared buffer 714, a web scale circuit 716, a time stamper 718, a synchronous Ethernet (SyncE) circuit 720, and a serializer/deserializer 722.

The programmable network processor 702 can be programmed to perform functions that are conventionally performed by integrated circuits (IC) that are specific to switching, routing line card, and routing fabric. The programmable network processor 702 may be programmable using the programming protocol-independent packet processors (P4) language, which is a domain-specific programming language for network devices for processing packets. The programmable network processor 702 may have a distributed P4 NPU architecture that may execute at line rate for small packets with complex processing. The programmable network processor 702 may also include optimized and shared NPU fungible tables. In some aspects, the programmable network processor 702 supports a unified software development kit (SDK) to provide consistent integrations across different network infrastructures, and simplifies networking deployments. The application specific integrated circuit (ASIC) 700 can also include embedded processors to offload various processes, such as asynchronous computations.

The programmable network processor 702 includes a programmable NPU host 704 that may be configured to perform various management tasks, such as exception processing and control-plane functionality. In one aspect, the programmable NPU host 704 can be configured to perform high-bandwidth offline packet processing such as for example, operations, administration, and management (OAM) processing and MAC learning.

The ASIC 700 includes counters and meters 706 for traffic policing, coloring, and monitoring. As an example, the counters and meters 706 include programmable counters used for flow statistics and OAM loss measurements. The programmable counters may also be used for port utilization, microburst detection, delay measurements, flow tracking, elephant flow detection, and congestion tracking, etc.

The telemetry 710 is configured to provide in-band telemetry information such as per-hop granular data in the forwarding plane. The telemetry 710 may observe changes in flow patterns caused by microbursts, packet transmission delay, latency per node, and new ports in flow paths. The NPU database 712 provides data storage for one or more devices, for example, the programmable network processor 702 and the programmable NPU host 704. The NPU database 712 can include different types of storage, such as key-value pair, block storage, etc.

In some aspects, the ASIC 700 includes a shared buffer 714 that can be configured to buffer data, configurations, packets, and other content. The shared buffer 714 can be utilized by various components such as the programmable network processor 702 and the programmable NPU host 704. A web scale circuit 716 may be configured to dynamically allocate resources within the ASIC 700 for scale, reliability, consistency, fault tolerance, etc.

In some aspects, the ASIC 700 can also include a time of day (ToD) time stamper 718 and a SyncE circuit 720 for distributing a reference to subordinate devices. For example, the time stamper 718 may support IEEE-1588 for ToD functions. In some aspects, the time stamper 718 includes support for a precision timing protocol (PTP) for distributing frequency and/or phase to enable subordinate devices to synchronize with the ASIC 700 for nano-second level accuracy.

The serializer/deserializer 722 is configured to serialize and deserialize packets into electrical signals and data. In one aspect, the serializer/deserializer 722 supports sending and receiving data using non-return-to-zero (NRZ) modulation or pulse amplitude modulation 4-level (PAM4) modulation. In one illustrative aspect, the hardware components of the ASIC 700 provide features for terabit-level performance based on flexible port configuration, nanosecond-level timing, and programmable features. Non-limiting examples of hardware functions that the application specific integrated circuit (ASIC) 700 can support include IP tunneling, multicast, network address translation (NAT), port address translation (PAT), security and quality of service (QoS) access control lists (ACLs), ECMP, congestion management, distributed denial of service (DDos) migration using control plane policing, telemetry, timing and frequency synchronization, and so forth.

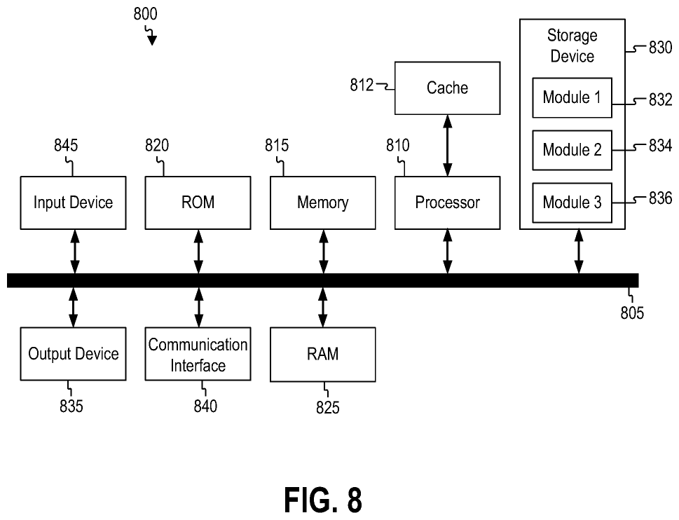

FIG. 8 shows an example of computing system 800, which can be for example any computing device making up the various roles described above or any component thereof in which the components of the system are in communication with each other using connection 805. Connection 805 can be a physical connection via a bus, or a direct connection to processor 810, such as in a chipset architecture. Connection 805 can also be a virtual connection, networked connection, or logical connection.

In some embodiments, computing system 800 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 800 includes at least one processing unit (CPU or processor) 810 and connection 805 that couples various system components including system memory 815, such as read only memory (ROM) 820 and random access memory (RAM) 825 to processor 810. Computing system 800 can include a cache of high-speed memory 812 connected directly with, in close proximity to, or integrated as part of processor 810.

Processor 810 can include any general purpose processor and a hardware service or software service, such as services 832, 834, and 836 stored in storage device 830, configured to control the processor 810 as well as a special-purpose processor where software instructions are incorporated into the actual processor design. Processor 810 can essentially be a completely self-contained computing system, containing multiple cores or processors, a bus, memory controller, cache, etc. A multi-core processor can be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. There is no restriction on operating on any particular hardware arrangement and therefore the basic features here can easily be substituted for improved hardware or firmware arrangements as they are developed.

Storage device 830 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 830 can include software services, servers, services, etc., that when the code that defines such software is executed by the processor 810, it causes the system to perform a function. In some embodiments, a hardware service that performs a particular function can include the software component stored in a computer-readable medium in connection with the necessary hardware components, such as processor 810, connection 805, output device 835, etc., to carry out the function.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

For clarity of explanation, in some instances, the present technology can be presented as including individual functional blocks including functional blocks comprising devices, device components, steps or routines in a method embodied in software, or combinations of hardware and software.

Any of the steps, operations, functions, or processes described herein can be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general-purpose computer, special purpose computer, or special purpose processing device to perform a certain function or group of functions. Portions of computer resources used can be accessible over a network. The computer executable instructions can be, for example, binaries, intermediate format instructions such as assembly language, firmware, or source code. Examples of computer-readable media that can be used to store instructions, information used, and/or information created during methods according to described examples include magnetic or optical disks, solid state memory devices, flash memory, universal serial bus (USB) devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter can have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Illustrative examples of the disclosure include:

Aspect 1. A method for configuring a network group, comprising: transmitting a topology request from a first leaf node to a first spine node; in response to receiving a network topology reply from a second leaf node, generating a network topology identifying a group of leaf nodes, the network topology reply including network information associated with the second leaf node, and in response to a request to send a message from a first network node connected to the first leaf node to a second network node connected to the second leaf node, transmitting the message to the second leaf node based on the network information from the network topology reply, wherein the first spine node or a second spine node are configured to receive the message and transmit the message to the second leaf node.

Aspect 2. The method of Aspect 1, wherein the topology request is broadcasted to leaf nodes connected to the first spine and the second spine.

Aspect 3. The method of any of Aspects 1 to 2, wherein the network information includes at least one TLV including at least one of interface information, port information of the second leaf node, host routes associated with the second leaf node, and encapsulation information.

Aspect 4. The method of any of Aspects 1 to 3, wherein the group of leaf nodes is stored in a hardware buffer of the first leaf node.

Aspect 5. The method of any of Aspects 1 to 4, wherein each leaf node in the group of leaf nodes stores the group of leaf nodes in a hardware buffer.

Aspect 6. The method of any of Aspects 1 to 5, further comprising receiving keep alive messages from each leaf node in the group of leaf nodes, wherein each keep alive message is multicast from a corresponding leaf node.

Aspect 7. The method of any of Aspects 1 to 6, wherein the keep alive message are received on a regular interval, wherein the regular interval is greater than 50 milliseconds and less than 5000 milliseconds.

Aspect 8. The method of any of Aspects 1 to 7, further comprising: determining at least three sequential keep alive messages from the second leaf node have not been received by the first leaf node; and removing the second leaf node from the set of leaf nodes and the network information associated with the second leaf node.

Aspect 9. The method of any of Aspects 1 to 8, further comprising: multicasting a keep alive message on a regular interval.

Aspect 10. The method of any of Aspects 1 to 9, further comprising: identifying a network change associated with an edge device connected to the first leaf node; and multicasting a network change message including the network change, wherein the message is addressed to the group of leaf nodes.

Aspect 11. The method of any of Aspects 1 to 10, wherein the first spine node and the second spine node are configured to multicast the network change message to the group of leaf nodes without providing the network change message to a software layer.

Aspect 12. The method of any of Aspects 1 to 11, wherein the group of leaf nodes are configured to train a machine learning model.

Aspect 13. The method of any of Aspects 1 to 12, wherein the first leaf node, the second leaf node, the first spine node, and the second spine node each include a hardware circuit that is configured to multicast messages without providing message to a software layer for inspection.

Aspect 14. An apparatus for configuring a network group includes a storage (implemented in circuitry) configured to store instructions and a processor. The processor configured to execute the instructions and cause the processor to: transmit a topology request from a first leaf node to a first spine node; in response to receiving a network topology reply from a second leaf node, generate a network topology identifying a group of leaf nodes, the network topology reply including network information associated with the second leaf node, and in response to a request to send a message from a first network node connected to the first leaf node to a second network node connected to the second leaf node, transmit the message to the second leaf node based on the network information from the network topology reply, wherein the first spine node or a second spine node are configured to receive the message and transmit the message to the second leaf node

Aspect 15. The apparatus of Aspect 14, wherein the topology request is broadcasted to leaf nodes connected to the first spine and the second spine.

Aspect 16. The apparatus of any of Aspects 14 to 15, wherein the network information includes at least one TLV including at least one of interface information, port information of the second leaf node, host routes associated with the second leaf node, and encapsulation information.

Aspect 17. The apparatus of any of Aspects 14 to 16, wherein the group of leaf nodes is stored in a hardware buffer of the first leaf node.

Aspect 18. The apparatus of any of Aspects 14 to 17, wherein each leaf node in the group of leaf nodes stores the group of leaf nodes in a hardware buffer.

Aspect 19. The apparatus of any of Aspects 14 to 18, wherein the processor is configured to execute the instructions and cause the processor to: receive keep alive messages from each leaf node in the group of leaf nodes, wherein each keep alive message is multicast from a corresponding leaf node.

Aspect 20. The apparatus of any of Aspects 14 to 19, wherein the keep alive message are received on a regular interval, wherein the regular interval is greater than 50 milliseconds and less than 5000 milliseconds.

Aspect 21. The apparatus of any of Aspects 14 to 20, wherein the processor is configured to execute the instructions and cause the processor to: determine at least three sequential keep alive messages from the second leaf node have not been received by the first leaf node; and remove the second leaf node from the set of leaf nodes and the network information associated with the second leaf node.

Aspect 22. The apparatus of any of Aspects 14 to 21, wherein the processor is configured to execute the instructions and cause the processor to: multicaste a keep alive message on a regular interval.

Aspect 23. The apparatus of any of Aspects 14 to 22, wherein the processor is configured to execute the instructions and cause the processor to: identify a network change associated with an edge device connected to the first leaf node; and multicaste a network change message including the network change, wherein the message is addressed to the group of leaf nodes.

Aspect 24. The apparatus of any of Aspects 14 to 23, wherein the first spine node and the second spine node are configured to multicast the network change message to the group of leaf nodes without providing the network change message to a software layer.

Aspect 25. The apparatus of any of Aspects 14 to 24, wherein the group of leaf nodes are configured to train a machine learning model.

Aspect 26. The apparatus of any of Aspects 14 to 25, wherein the first leaf node, the second leaf node, the first spine node, and the second spine node each include a hardware circuit that is configured to multicast messages without providing message to a software layer for inspection.

Aspect 27. A disaggregated network, comprising: a first spine node including a multicast circuit for processing multicast packets; a second spine node including a multicast circuit for processing multicast packets; and a plurality of leaf nodes, wherein each leaf node is coupled to the first spine node and the second spine node, wherein each leaf node includes including a multicast circuit for processing multicast packets, and wherein each leaf node is configured to transmit a discovery message for discovering a group, a discovery reply message for providing information to a leaf node with part of a network topology associated with the leaf node, a keepalive message for maintaining a membership to the group, and a status update for promulgating network changes to other leaf nodes.

Aspect 28. The disaggregated network of Aspect 27, wherein each leaf node forms a network topology that is managed in hardware based on each discovery reply message.

Aspect 29. The disaggregated network of any of Aspects 27 to 28, wherein each leaf node is configured to remove an unavailable leaf node based on a quantity of missing keepalive messages.

Aspect 30. The method of any of Aspects 27 to 29, wherein each of the first spine node, the second spine node, and the plurality of leaf nodes include a hardware circuit configured to multicast messages without providing the message to a software layer for inspection.

Aspect 31. The method of any of Aspects 27 to 30, wherein each of the first spine node, the second spine node, and the plurality of leaf nodes include a hardware circuit configured to receive multicast messages without providing the message to a software layer for inspection.

Aspect 32. The method of any of Aspects 27 to 31, wherein each leaf node stores a plurality of leaf nodes in a hardware buffer.

Aspect 33. The method of any of Aspects 27 to 32, wherein the first spine node and the second spine node are unaware of the plurality of leaf nodes.

Aspect 34. A non-transitory computer-readable medium comprising instructions which, when executed by one or more processors, cause the one or more processors to perform operations according to any of Aspects 1 to 13.

Aspect 35. An apparatus comprising means for performing operations according to any of Aspects 1 to 13.

What is claimed is:

1. A method for configuring a network group, comprising:
transmitting a topology request from a first leaf node to at least one spine node;
in response to receiving a network topology reply from a second leaf node, generating a network topology identifying a group of leaf nodes, the network topology reply including network information associated with the second leaf node, and
in response to a request to send a message from a first network node connected to the first leaf node to a second network node connected to the second leaf node, transmitting the message to the second leaf node based on the network information from the network topology reply;
wherein a first spine node or a second spine node of the at least one spine node are configured to receive the message and transmit the message to the second leaf node, and
wherein the first leaf node includes a multicast circuit for processing multicast packets for a disaggregated switching fabric associated with the first leaf node, the second leaf node, and the at least one spine node.

2. The method of claim 1, wherein the topology request is broadcasted to leaf nodes connected to the first spine node and the second spine node.

3. The method of claim 1, wherein the network information includes at least one TLV including at least one of interface information, port information of the second leaf node, host routes associated with the second leaf node, and encapsulation information.

4. The method of claim 1, wherein the group of leaf nodes is stored in a hardware buffer of the first leaf node.

5. The method of claim 1, wherein each leaf node in the group of leaf nodes stores the group of leaf nodes in a hardware buffer.

6. The method of claim 1, further comprising receiving keep alive messages from each leaf node in the group of leaf nodes, wherein each keep alive message is multicast from a corresponding leaf node.

7. The method of claim 6, wherein the keep alive message are received on a regular interval, wherein the regular interval is greater than 50 milliseconds and less than 5000 milliseconds.

8. The method of claim 6, further comprising:
determining at least three sequential keep alive messages from the second leaf node have not been received by the first leaf node; and
removing the second leaf node from the group of leaf nodes and the network information associated with the second leaf node.

9. The method of claim 1, further comprising:
identifying a network change associated with an edge device connected to the first leaf node; and
multicasting a network change message including the network change, wherein the message is addressed to the group of leaf nodes.

10. The method of claim 1, wherein the first leaf node, the second leaf node, the first spine node, and the second spine node each include a hardware circuit that is configured to multicast messages without providing information to a software layer for inspection.

11. An apparatus for configuring a network group, comprising:
a storage configured to store instructions;
a processor configured to execute the instructions and cause the processor to:
transmit a topology request from a first leaf node to a first spine node;
in response to receiving a network topology reply from a second leaf node, generate a network topology identifying a group of leaf nodes, the network topology reply including network information associated with the second leaf node; and
in response to a request to send a message from a first network node connected to the first leaf node to a second network node connected to the second leaf node, transmit the message to the second leaf node based on the network information from the network topology reply;
wherein the first spine node or a second spine node are configured to receive the message and transmit the message to the second leaf node, and
wherein the first leaf node includes a multicast circuit for processing multicast packets for a disaggregated switching fabric associated with the first leaf node, the second leaf node, and the at least one spine node.

12. The apparatus of claim 11, wherein the topology request is broadcasted to leaf nodes connected to the first spine node and the second spine node.

13. The apparatus of claim 11, wherein the network information includes at least one TLV including at least one of interface information, port information of the second leaf node, host routes associated with the second leaf node, and encapsulation information.

14. The apparatus of claim 11, wherein the group of leaf nodes is stored in a hardware buffer of the first leaf node.

15. The apparatus of claim 11, wherein each leaf node in the group of leaf nodes stores the group of leaf nodes in a hardware buffer.

16. The apparatus of claim 11, wherein the processor is configured to execute the instructions and cause the processor to: receive keep alive messages from each leaf node in the group of leaf nodes, wherein each keep alive message is multicast from a corresponding leaf node.

17. The apparatus of claim 16, wherein the processor is configured to execute the instructions and cause the processor to:
determine at least three sequential keep alive messages from the second leaf node have not been received by the first leaf node; and
remove the second leaf node from the group of leaf nodes and the network information associated with the second leaf node.

18. The apparatus of claim 11, wherein the processor is configured to execute the instructions and cause the processor to:
identify a network change associated with an edge device connected to the first leaf node; and
multicast a network change message including the network change, wherein the message is addressed to the group of leaf nodes.

19. The apparatus of claim 11, wherein the first leaf node, the second leaf node, the first spine node, and the second spine node each include a hardware circuit that is configured to multicast messages without providing message to a software layer for inspection.

20. A disaggregated network, comprising:
a first spine node including a multicast circuit for processing multicast packets;
a second spine node including a multicast circuit for processing multicast packets; and
a plurality of leaf nodes,
wherein each leaf node is coupled to the first spine node and the second spine node,
wherein each leaf node includes a multicast circuit for processing multicast packets, and
wherein each leaf node is configured to transmit a discovery message for discovering a group, a discovery reply message for providing information with part of a network topology associated with the leaf node, a keepalive message for maintaining a membership to the group, and a status update for promulgating network changes to other leaf nodes.
